(19) United States
(12) Patent Application Publication
(10) Pub. No.: US 2003/0132375 A1
(43) Pub. Date: Jul. 17, 2003

(54) Tunable laser calibration system

(76) Inventor: Stephen Frank Blazo, Mulino, OR (US)

Correspondence Address: STEPHEN BLAZO, 14711 S BUCKNER CREEK ROAD, MULINO, OR, 97042, US

(21) Appl. No.: 10/047,656

(22) Filed: Jan. 17, 2002

(51) Int. Cl. G01D 18/00

(52) U.S. Cl. 250/252.1

(57) ABSTRACT

This invention provides a means of calibrating a tunable laser to high accuracy over a wide wavelength range. A gas cell is combined with an optical comb generator along with an interpolating clock which can be used to calibrate tunable lasers to high resolution and reference the calibration to gas cell absorption lines known for their exceptional accuracy and stability. The techniques used rely on simple counting and thus are easy to implement as compared to previous techniques that use analog curve fitting.

### STATEMENT REGARDING FEDERALLY SPONSORED RESEARCH AND DEVELOPMENT

Not Applicable

### BACKGROUND OF THE INVENTION

This invention relates to the use of gas cell absorption lines and an optical comb generator to calibrate the wavelength or optical frequency scale of a tunable laser.

Tunable lasers are widely used in the fiber optic communication market. A typical application would be for the testing of a dense wavelength division multiplexing (DWDM) demultiplexer. A DWDM optical signal may contain many optical signals of different wavelengths each one of multigbit bit rate. The demultiplexer takes a DWDM optical signal and separates the individual optical wavelengths. To test this component a tunable laser is often used. In this application the tunable laser is connected to the input of the demultiplexer and detectors with A/D converters are connected to each output fiber. For a big demultiplexer this may be 40 or more output fibers. The laser is scanned and the records on each A/D converter are recorded. A scan may involve 10000 or more samples, for example a scan of 50 nanometers with a sample every 5 picometers. A key feature for the usefulness of the data is the wavelength or optical frequency accuracy of the samples. The tunable laser tuning means, either mechanical or electrical, typically does not allow the required accuracy to be met by itself. One technique for calibrating the samples wavelength that is commonly used is to measure the wavelength at each sample using a wavelength meter such as those made by Burleigh Inc. or Agilent Inc. Since the wavelength meters accuracy is very high this technique can achieve the required accuracy but the laser scan must be stopped at each sample for the wavelength meter to make a measurement. This means that a scan might take hours to complete, reducing throughput. The expense of the wavelength meter is another drawback.

Another means of tunable laser calibration that might be used is to split the output of the tunable laser and send part of the signal to a calibration system that can determine the wavelength real time or record the necessary information to allow the wavelength to be determined for each sample in postprocessing of the records. Gas molecular absorption has been used for this purpose. In this case part of the tunable laser signal is passed through a gas that has absorption lines at precise locations in the band of interest. Gases such as acetylene and hydrogen cyanide have been used for this purpose. The National Institute of Standards and Technology (NIST) sells such gas cells, the SRM2517 and SRM 2519. These materials have a limited number and position of absorption lines. Typically the transmission of the cell is digitized and recorded along with the sample records from the other A/D converters from the device under test. The positions of the gas lines are used to correct and determine the wavelength scale of the samples. Interpolation and extrapolation techniques are used to correct the data record or generate a corrected scanning waveform for the tunable laser. These techniques rely on the scanning of the laser to be smooth and reproducible typically using analog curve fitting. This fitting is difficult making the software job time consuming and is subject to assumptions about the nature of scanning errors which may not be valid. Although the position of the gas lines is extremely accurate the limited number and position of gas lines places significant limitations on the quality of the calibration.

### BRIEF SUMMARY OF THE INVENTION

Accordingly the present invention utilizes a gas cell in combination with an optical comb filter to achieve a calibration that simultaneously achieves an easy implementation due to its digital counting nature, high absolute accuracy due to its reliance on gas cell lines for primary calibration points, and the ability to calibrate over a wide frequency range. This is achieved by having the optical comb filter have a repetition rate corresponding to a small optical frequency difference, the comb filter optical frequency period being much less then the optical frequency difference between the gas lines themselves. Although the comb generator does not typically have a good enough long term stability or accuracy, through techniques described in the detailed description, the gas line positions can be used to calibrate the comb generator. The determination of the tunable laser frequency at the data samples is then reduced to counting without the necessity of analog interpolation or extrapolation. If the comb generator comb spacing is too great for the desired resolution, another clock signal whose clock rate is higher then the repetition rate of the comb filter during a laser scan can be used to digitally interpolate between the comb pulses and provide a tunable laser calibration, in principle, of any desired resolution. Several objects and advantages of the present invention are:

1. Provide a wavelength/frequency calibration of a tunable laser by using a combination of a gas cell and a comb filter whose frequency spacing is substantially less then the gas line spacing.

2. The calibration to be achieved by counting comb filter pulses, calibrating them against the gas cell lines, and not relying or requiring analog interpolation or extrapolation.

3. An alternate embodiment, which includes a clock generator, to digitally interpolate the comb filter pulses again by counting techniques, improving the resolution, if the comb filter has insufficient resolution for the application.

### BRIEF DESCRIPTION OF THE DRAWINGS

FIG. 1 is a block diagram of a preferred embodiment of the invention including the possible use of an interpolating clock

FIG. 2 is a set of sample waveforms in the case an interpolating clock is used with the horizontal axis being the optical frequency scan of the tunable laser

FIG. 3 is the contents of the memory locations present at each sample point in the case an interpolating clock is used

FIG. 4 is a set of sample waveforms in the case an interpolating clock is not used

FIG. 5 is the contents of the memory locations present at each sample point in the case when an interpolating clock is not used

### DETAILED DESCRIPTION OF THE INVENTION

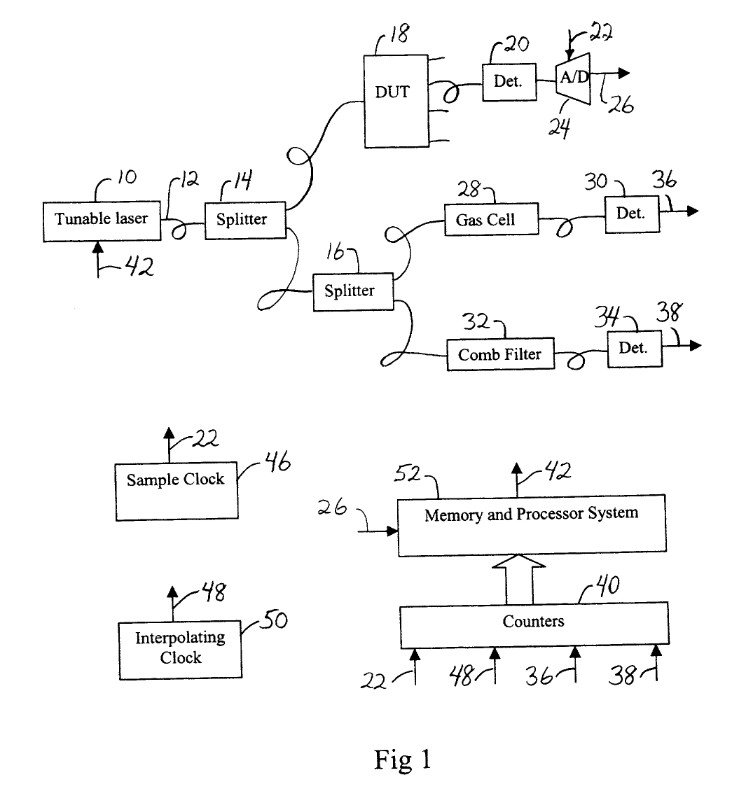

A preferred embodiment of the present invention is shown in FIG. 1. The tunable laser 10 is scanned with scanning signal 42 controlled be processor system 52. The output of the laser is fed to splitter 14 over fiber optic cable 12. One output of the splitter is made available to device or devices under test (DUT) 18. This device maybe an element such as a fiber optic demultiplexer that may have many outputs. Only one output is shown which is fed to fiber optic detector 20. The fiber optic detector output is fed to a A/D converter 24 which is clocked by sample clock 22 generated by sample clock generator 46. The output of the A/D converter 26 is stored in the memory/processor system 52 for further analysis. The other output of the splitter 14 is delivered to another splitter 16. One output of the splitter 16 is delivered to gas cell 28. The gas cell will typically consist of an input fiber optic collimator, a tube filled with a gas that has accurately known absorption lines in the frequency range of the tunable laser, and an output collimator that refocuses the light into an output fiber. The output of the gas cell is delivered to detector circuit 30 which converts the signal to an electrical one and processes it to output a pulse at the gas cell absorption lines positions. This may involve an operation as simple as threshold detection or may involve more complicated procedures. The other output of the splitter 16 is delivered to an optical comb filter 32. This comb filter is typically a fiber Fabry-Perot filter formed by a length of fiber optic fiber with the end faces polished and coated with a material with that forms a partially reflective mirror at each end when the comb filter is connected to an input and output fiber. When this element is scanned with the tunable laser output the output of the comb filter will be a repetitive series of pulses whose frequency repetition period is known as the free spectral range. The free spectral range is determined by the optical length of the comb filter fiber and the sharpness and narrowness of the comb filter pulses is determined by the reflectivity of the mirror ends by standard Fabry-Perot interferometer theory. Typically the fiber length would be in the range of 2 to 30 cm and the reflectivity from 20% to 90%. This results in a free spectral range of between 1.0 Ghz and 15 Ghz corresponding to a 0.0027 nm to 0.040 nm wavelength difference for signals in the 1550 nm band. Longer fiber lengths can be used to achieve a higher resolution but generally will need to be coiled for practical application. Often coiling will introduce birefringence in the fiber and this can cause undesirable polarization sensitivity. The comb filter peak spacing is the basic resolution of the system when the interpolating clock is not used. The output of the comb filter is delivered to detector circuit 34 the output of which 38 is a pulse train at the position of the comb filter pulses. The output of the gas cell detector and comb filter detector is fed to a counter circuit 40. The counter circuit also receives the sample clock 22 and the interpolating clock 48. The interpolating clock 48 generated by interpolating clock circuit 50 is a clock signal whose frequency is substantially higher then the repetition rate generated by the comb filter during a scan of the tunable laser. Its purpose is to improve the overall frequency resolution in the case where the comb filter resolution is insufficient. The use of an interpolating clock or not is subject to the resolution requirements of the application and the resolution of the comb filter. Two embodiments are described one with an interpolating clock and one without.

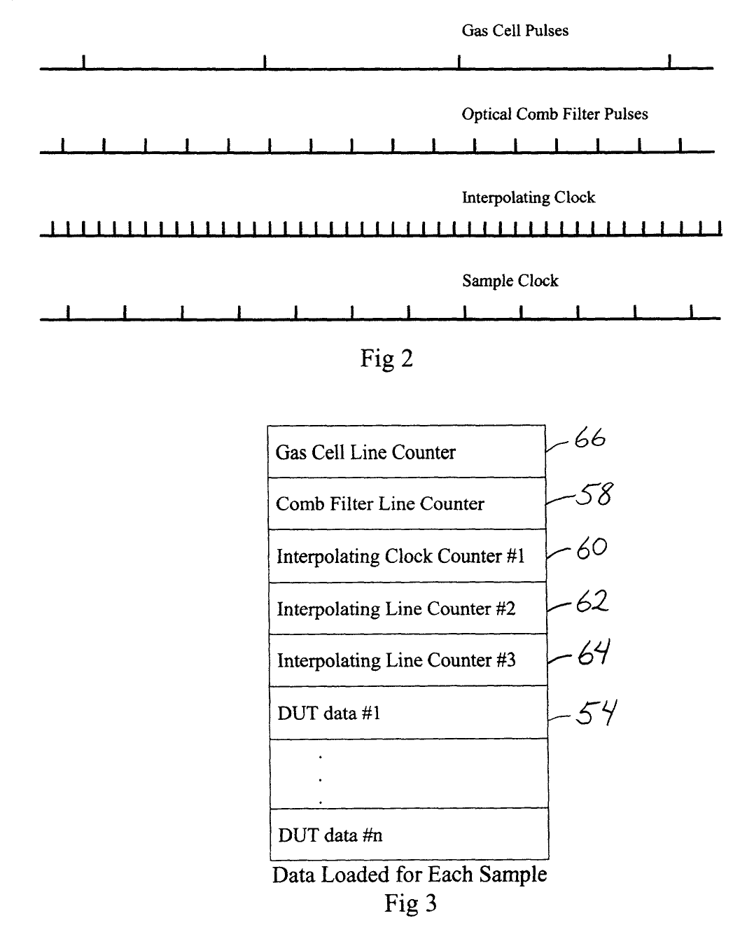

The outputs of the counter circuit are clocked into the memory/processor system at the sample clock rate. The data for each sample will include the data from the DUT(s) as well as information from the counters that can be used to determine the actual wavelength at each sample. Many sets of data with equivalent performance are possible. One such set is shown in FIG. 3 for the case where an interpolating clock is used. A sample waveform of the trigger inputs of the counters for this case is also shown in FIG. 2. Note the typical relation of the pulse rate, the gas cell lines are relatively sparse with the comb filter pulses and sample pulses more numerous. The most frequent of all is the interpolating clock pulses. In FIG. 3 the GAS LINE COUNTER contents 66 is the number of gas cell lines from start of scan to sample. The COMB FILTER LINE COUNTER contents 58 is the number of comb filter lines counted from start of scan to sample. The INTERPOLATING CLOCK COUNTER #1 contents 60 is the number of interpolating clock pulses from the gas line to the next comb pulse. Note that this memory location need only have valid contents for samples just after the gas cell lines. The gas cell lines are the points of absolute wavelength calibration for the system. The INTERPOLATING CLOCK COUNTER #2 contents 62 is the number of interpolating clock pulses from the last comb filter pulse to the sample. The INTERPOLATING CLOCK COUNTER #3 contents 64 is the number of interpolating clock pulses present between two comb filter pulses immediately prior to the sample. Also shown in FIG. 3 are memory locations 54 containing the information from the DUT(s) at each sample.

The processor system can use the information described to position each of the data samples at an optical frequency position with an error of less then that described by the optical frequency scan during one interpolation clock pulse. Alternatively the processor system may use the information derived to correct the scanning waveform to the tunable laser by means of a corrected scanning signal 42 that results in a scan that is linear with sample clock.

The identification of the optical frequency of each sample using the information stored at each sample is relatively simple. The data from 58 and 66 can be used to derive the number of whole comb filter lines that are present between gas cell lines. This can be combined with information in 64 and 60 to more finely resolve the data into the number of fractional comb filter pulses that are present between gas cell lines. Note that the number of interpolating pulses between the comb filter pulses will not necessarily be constant but will be relatively slowly varying. The counter 64 keeps track of this variation and allows accurate calulation of the actual fraction. Thus we can derive the average optical frequency difference between comb filter lines between each pair of gas lines. If the material in the Fabry-Perot comb filter had no dispersion this frequency difference would be uniform over all optical frequencies but this is generally not the case. To correctly identify each sample points optical frequency with high accuracy the processor will generally make use of the dispersion characteristics of the fiber or other material used in the comb filter generator. The position of each sample is determined by the number of integral comb pulses from the gas line to the sample point plus the number of fractional ones determined by 62 and 64. With this data the position of each sample can be determined by simple counting to a resolution of that determined by the interpolating clock and referenced to the gas cell lines that are typically known to a very high degree of accuracy. The extrapolation accuracy away from the gas cell lines is only limited by the accuracy the dispersion calculation can give. For a comb generator made from a fiber Fabry-Perot the fiber dispersion is typically quite well known. Thus the correction for dispersion, which is typically a small one, is accurately known so this does not typically introduce a significant source of error.

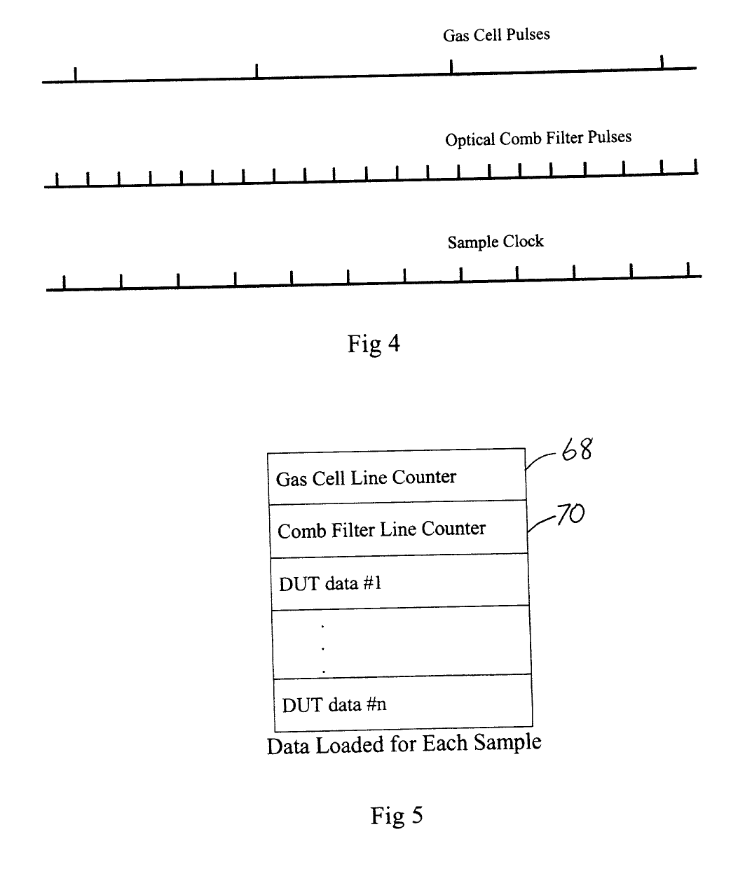

In FIG. 4 and FIG. 5 a data set that can be used in the case where the interpolating clock is not required for the resolution needed. In this case the interpolating clock is not present. A sufficient set of data stored for each data sample is shown in FIG. 5. The GAS CELL LINE COUNTER contents 68 is the number of gas cell lines from start of scan to sample. The COMB FILTER LINE COUNTER contents 70 is the number of comb filter pulses are present from the start of scan to the sample point. The counter contents can be used to derive the number of comb filter pulses between the gas cell line. This calibrates the comb filter line spacing. This information can be combined with dispersion calculations of the comb filter if errors introduced be ignoring it are too large. Thus we can locate each sample point to a resolution corresponding to a comb filter pulse spacing. The limit on the resolution determined by the comb filter period is determined by the optical length of the Fabry-Perot cavity. For a fiber Fabry-Perot based system this length can be very long indeed giving the possibility of very high resolution. The limit for straight lengths of fiber would be in the range of 30 cm or so. At cavities longer then 30 cm or so the fiber must be coiled to be practical. This introduces birefringence in the fiber. In this case, for arbitrary input polarization, the comb filter will exhibit two pulse trains representing the optical path for the two principle states of polarization. This can be eliminated by using polarization maintaining fiber for the fiber Fabry-Perot filter and controlling the input polarization state. It is also possible to control the coiling process of the fiber to reduce the birefringence to a negligible value in which case polarization maintaining fiber is not required. In this case a fiber length of 1 meter will achieve a comb filter period of about 0.8 picometers which is sufficient for almost all applications.

### CONCLUSIONS, RAMIFICATIONS, AND SCOPE

The techniques described by this invention can be used to calibrate a tunable laser using simple counting techniques. These are much easier to implement then techniques that rely on analog curve fitting previously used. They also give the corrected wavelength at each sample point with much less restrictive assumptions on the functional form of the nonlinearities of the scanning of the laser as compared to the prior art. The resolution can be quite high. Without using an interpolating clock the resolution is determined by the comb generator which can be made to have a resolution of 0.01 nm or even better. The use of an interpolating clock allows arbitrary high resolution to be achieved.

Although the description above contains many specifities, these should not be construed as limiting the scope of the invention but as merely providing illustrations of some of the presently preferred embodiments of the invention. For example the exact counter configuration could be easily modified to achieve the same goal. The comb filter is described as a fiber based Fabry-Perot but the only requirement is that it produce a pulse train quasiperiodic in optical frequency over an optical frequency range that includes the gas cell lines and the tunable laser output.

1. Apparatus for calibrating the wavelength scale of a tunable laser comprising a tunable laser and scanning means that allows continuous monotonic tuning of the output frequency, a frequency reference cell containing a gaseous medium having absorption lines in the frequency range of the laser, a optical comb filter that generates a transmission function that is quasiperiodic with a period substantially finer then the frequency difference between gas cell absorption lines, a set of optical splitters that divide the output of the tunable laser between an output available for the device or devices under test, the gas cell, and the optical comb filter, a sample clock for clocking the storage of data from the device or devices under test and the output of the calibration counters, a set of calibration counters that log the passage of the gas cell lines and the comb filter lines, and a memory and processing system that is used to calculate the wavelength position.

2. Apparatus in 1. combined with an interpolating clock whose frequency is substantially higher then the clock rate generated by the passage of the comb filter lines and a counter set that allows the frequency difference resolution of the calibration system to be improved to that determined by the interpolating clock hence less then that determined by the comb filter period.
